(19) United States
(12) Patent Application Publication
(10) Pub. No.: US 2007/0146235 A1
(43) Pub. Date: Jun. 28, 2007

(54) Navigation system utilizing portable and adjustable heads up display

(76) Inventors: James Nolan, (US); Laura White, (US); Paul Ashcraft, (US)

Correspondence Address: SCHNECK & SCHNECK, P.O. BOX 2-E, SAN JOSE, CA, 95109-0005, US

(21) Appl. No.: 10/090,389

(22) Filed: Mar. 1, 2002

(51) Int. Cl. G09G 5/00

(52) U.S. Cl. 345/7

(57) ABSTRACT

A navigation system with a portable heads up display (HUD). The HUD comprises a housing rotably mounted on a stand. The housing holds a device for generating an image that can be projected onto a vehicle windshield, for example a vacuum fluorescent display (VFD) module. Preferably, the navigation system is a NavMate® Navigation System from Visteon Technologies LLC, and the HUD is operatively connected to the navigation system by a high speed serial interface, for example an RS232 interface. An exemplary HUD includes a microcontroller, frame buffer, and a graphic display module. A preferred image generator is a Futaba GP1045A02A graphic display module.

### FIELD OF THE INVENTION

This invention relates generally to the field of navigation systems, and in particular is directed to a vehicle navigation system with a heads up display that is portable and adjustable.

### DESCRIPTION OF THE RELATED ART

Mobile navigation systems are used to guide a traveler to a desired destination. Generally, these systems take advantage of global positioning system (GPS) transceivers to note the location of the traveler. The location is often noted in longitude and latitude coordinates. The position of the traveler is compared to the desired destination, and visual and/or audio indications of current position, final destination, and/or specific directions for travel are provided. Thus, the traveler would enter the desired destination address and be provided navigation assistance to the ultimate destination. Examples of navigation systems, and components that may be used therewith, are described in U.S. Pat. No. 6,088,648, U.S. Pat. No. 5,867,133, U.S. Pat. No. 5,734,357, U.S. Pat. No. 5,724,243 U.S. Pat. No. 5,654,908, U.S. Pat. No. 5,646,639, U.S. Pat. No. 5,596,500, U.S. Pat. No. 5,544,061, U.S. Pat. No. 5,506,595, U.S. Pat. No. 5,430,655, U.S. Pat. No. 5,414,630, U.S. Pat. No. 5,386,216, U.S. Pat. No. 5,311,434, U.S. Pat. No. 5,303,159, U.S. Pat. No. 5,291,413, U.S. Pat. No. 5,291,412, U.S. Pat. No. 5,283,575, U.S. Pat. No. 5,243,529, U.S. Pat. No. 5,231,379, U.S. Pat. No. 4,925,272, and U.S. Pat. No. 4,804,836, all of which are incorporated by reference as if reproduced in full below.

For example, a NavMate® navigation system, available from Visteon Technologies, LLC of Sunnyvale, Calif., provides navigation assistance in response to entry of a destination, which may be designated by street addresses, intersections, points of interest, or freeway entrances and/or exits. The NavMate® navigation system has the capability of referencing longitude and latitude information to a point on a map.

In order to facilitate the use of a vehicle navigation system, a heads up display, or HUD, may be used that is either a virtual image type or a direct display type. A virtual image HUD projects a virtual image of a display image onto the windshield that is reflected so as to be at eye level with the vehicle driver. A half mirror or combiner may be provided to reflect an image towards a driver while minimizing interference with the driver's view of the road. In this way, the driver does not need to look away from the road to obtain information provided by the HUD. A direct display type of HUD includes a display that is mounted on the vehicle dash directly in the driver's field of vision. The direct display HUD is less desirable than the virtual image HUD as it takes up more of the driver's viewing area than a reflected image, and further the device blocks a portion of the driver's viewing area even when not in use. Mirrors or combiners to reflect an image towards a driver also reduce the driver's field of vision. Examples of direct and indirect devices for displaying information in a vehicle are provided in U.S. Pat. No. 6,100,943, and U.S. Pat. No. 5,422,812, which are incorporated by reference as if reproduced in full below.

With reference to U.S. Pat. No. 6,100,943, to Koide et al., a vacuum fluorescent display tube (VFD) is employed as part of a virtual image HUD system for providing vehicle information. The VFD display is built into the vehicle instrument panel. By use of a condenser lens inside of the vehicle dashboard and a combiner mounted upon the windshield, the display image of the VFD can be projected through a small opening in the vehicle dashboard and onto the combiner. In the alternative, a direct display HUD is disclosed that uses a front-light-emitting fluorescent display tube (FLVFD). This device is built into the dash with an FLVFD output facing the driver. A mirror mounted behind the FLVFD in the dash is used to reflect a rear facing FLVFD output towards the driver via a second window constructed into the dash. The displays of Koide et al require that the systems be permanently installed in the vehicle, and that their components be maintained in proper alignment in order to provide a focused image. This requires modification to the dashboard, and the systems cannot be readily moved to different vehicles. Further information on VFD and FLVFD devices can be found in “VFD Characteristics And Operation,” available from Futaba Corporation of America, 1605 Penny Lane, Schaumburg Ill. 60173, USA, or http://www.futaba.com/VFD/vfdAppNotes.htm. Further information on devices for data transfer and utilization can be found in Slater, Michael, “Microprocessor Based Design,” Prentice Hall, Englewood Clifts, N.J., (1989) (ISBN 0-13-582248-3

With reference to U.S. Pat. No. 5,422,812, to Knoll et al., a navigation system with HUD is disclosed. The system provides a first display that provides a map and/or detailed navigation information, and a second display that provides simple and easily reviewed directions. The first display may be a dash mounted video monitor, while the second display may be a HUD. The HUD is constructed from a display element mounted into a recess in the dashboard, a combiner or mirror mounted on the dash in the driver's line of sight, and a lens to focus the display element image onto the combiner or mirror. This system requires modification to the dashboard, and the system is not readily adaptable to other vehicles.

There remains a need for vehicle navigation systems with HUD capabilities that are portable, useful in a variety of vehicles, and are less costly to produce and install.

### BRIEF SUMMARY OF THE INVENTION

In an embodiment, a vehicle navigation system with a portable and adjustable heads up display (HUD) is disclosed. The HUD image is preferably generated by a vacuum fluorescent display (VFD), and the output is projected onto a vehicle windshield and reflected off the windshield towards the driver's position. A portion of the windshield may be treated to optimize the image reflected towards the driver's position. In a preferred embodiment, rather than or in addition to displaying a map, a navigation system provides short text and/or symbolic messages or icons to the HUD to provide navigation and other information to a driver with minimal distraction to the driver. Preferably, the HUD VFD is mounted on a portable stand that permits rotation of the VFD to accommodate varying dashboard shapes, windshield pitches, and driver preferences. In an alternative embodiment, the HUD includes a light intensity adjustment mechanism.

As the display image from the VFD sent to the windshield is a mirror image of the text that the driver sees, other options include a mechanism for varying the output of the VFD to permit direct viewing of display information or an inverting lens that inverts the VFD display image to permit direct viewing thereof.

In a preferred embodiment, a HUD module includes a VFD matrix display, a frame buffer, a graphics display chip, a controller, and a power supply. The VFD preferably has an XY matrix driven by a navigation system output via a serial port. The navigation system preferably provides TX and RX transmit, ground, and power signals. The power drives the VFD and the controller. The serial data is processed by the controller and directed to the graphics display chip (GDC) that translates the information for the XY matrix. Preferably the GDC output is fed to a frame buffer, which stores the image report, until it is downloaded from the frame buffer and fed to the display. In a preferred embodiment, a navigation command is equated to a symbolic instruction image, and the digital symbolic instruction image data is compressed and transferred serially to the HUD, where it is translated and stored in a frame buffer. When the data transfer is complete, the transferred digital data to then displayed as a video image.

It is to be understood that both the preceding summary and the detailed description that follows are intended merely to be exemplary and to explain further the invention claimed. The invention may be better understood by reference to the following detailed description read in conjunction with the accompanying drawings.

### BRIEF DESCRIPTION OF THE DRAWINGS

FIG. 1 illustrates a top plan view of the front portion of a vehicle incorporating a navigation system and HUD module in accordance with the present invention.

FIG. 2 illustrates a partial cross sectional side elevation view of a HUD module of the present invention projecting an image onto the windshield of a vehicle.

FIG. 3 illustrates a partial perspective view of a HUD module in accordance with the present invention.

FIG. 4 illustrates a plan view of a HUD module and its basic components constructed in accordance with the present invention.

FIG. 5a and FIG. 5b illustrate a VLP (Variable Length Packet) protocol used in an embodiment of the present invention for transmission of data for the HUD display.

FIG. 6 through FIG. 14 illustrate the commands and subroutines that can be used in the VLP protocol of FIGS. 5a and 5b for transferring a compressed data stream of an image over a serial link.

### DETAILED DESCRIPTION OF THE INVENTION

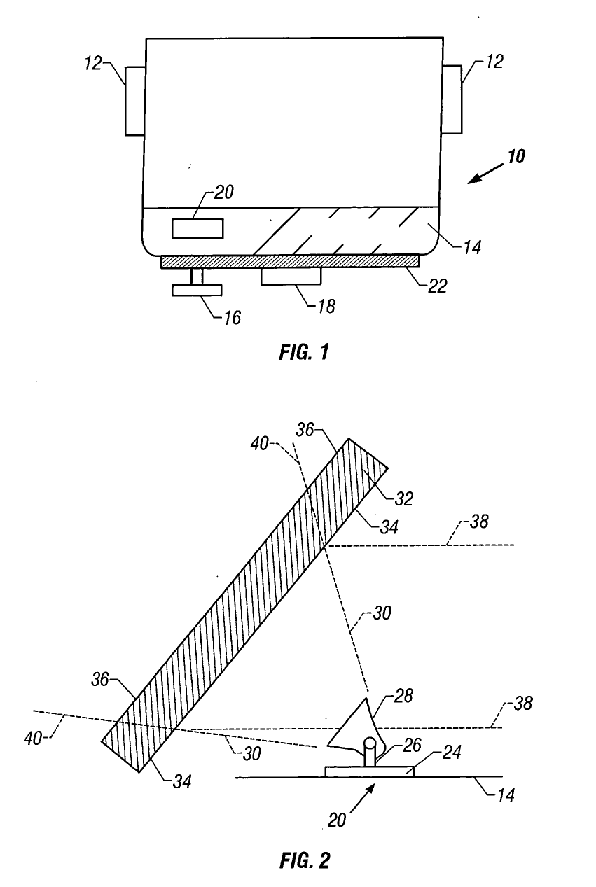

An embodiment of the present invention may be better understood with reference to FIG. 1. Vehicle 10 has front wheels 12, dashboard or dash 14, and steering wheel 16. A navigation system 18 is mounted on the front of vehicle control panel 22, and HUD module 20 is mounted on top of dash 14.

With reference to FIG. 2, a side view of HUD module 20 mounted on top of dash 14 is illustrated. HUD module 20 includes a base 24, swivel mount 26, and housing 28. Windshield 32 is shown in partial cross section, and has an inner surface 34 and an outer surface 36. An image, shown as dotted lines 30, is projected from module 20 towards windshield 32. Preferably, the angle of incidence of the image upon the inner surface 34 of windshield 32, causes at least a portion of the light, shown as dotted lines 38, to be reflected back in the general direction of steering wheel 16. An attenuated image passes through windshield 32, shown by dotted lines 40. Depending on the refractive index of the material forming and/or the coatings upon windshield 32, the attenuated image 40 may be at least partially reflected backwards at the interface of outer surface 36 of windshield 32 with the atmosphere. This may create a fuzzy or double image. Various mechanisms are available to counteract or reduce undesired interference. Preferably, adjustment of the intensity of the image projected at the windshield and the angle of projection will optimize the image quality seen by a driver situated behind steering wheel 16.

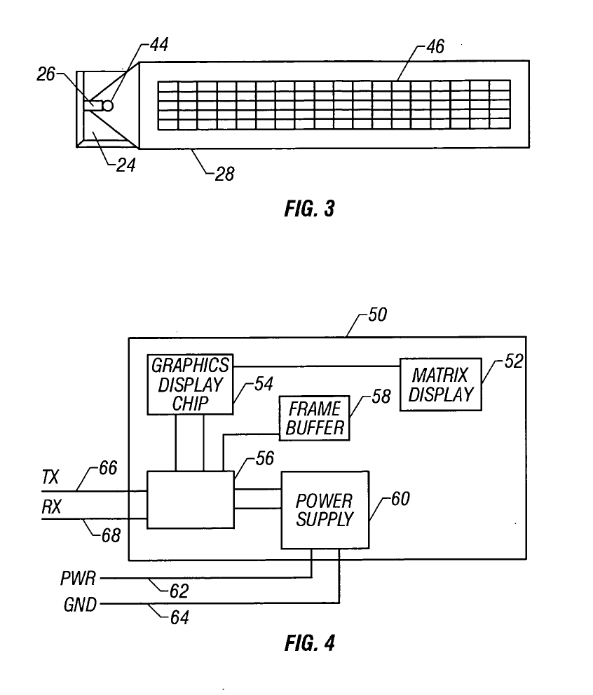

With reference to FIG. 3, a partial perspective view of the HUD module of FIG. 2 is illustrated. Base 24 and swivel mount 26 rotatably support housing 28 via pin 44. Pin 44 may rotate with respect to swivel mount 26.

Housing 28 includes display 46. Display 46 is preferably a vacuum fluorescent display (VFD) module, which preferably integrates a vacuum fluorescent display, a display controller, driver IC's and a power supply on a single printed circuit board (PCB). Suitable VFD modules for use with the present invention are commercially available, such as those available from Futaba Corporation of America, 1605 Penny Lane, Schaumburg Ill. 60173, U.S.A.

With reference to FIG. 4, an alternative embodiment of a HUD module 50 is illustrated. Matrix display 52 is operatively connected to graphics display chip 54, micro-controller 56, frame buffer 58 and power supply 60. Power supply 60 has a power lead 62 and ground lead 64. In a preferred embodiment, a 5 volt (V) power supply is sufficient to operate module 50. Micro-controller 56 has TX lead 66 and RX lead 68. Leads 62, 64, 66, and 68 may be operatively connected to a navigation system via a serial port. An RJ11 jack may be provided for rapid connection and disconnection of the module 50 to a navigation system.

In an embodiment, the matrix display has a grid with 180 pixels along its width and 32 pixels along its length, for a total of 5,760 pixels. For example, a LCD display may be used. The number of pixels or display elements may vary greatly depending on the usage requirements and display. A preferred matrix display for use in the present invention is incorporated in a Futaba GP1045A02A graphic display module using a 256×64 VFD. Specifications for the Futaba GP1045A02A are provided in Table 1 below.

In a preferred embodiment, the display module is operatively connected via a serial port to a NavMate® Navigation System, available from Visteon Technologies, LLC of Sunnyvale, Calif. For example, an RS232 serial interface can be utilized for communication between data terminal equipment (DTE) and data communications equipment (DCE), such as the HUD module and the navigation system. Preferably, the serial interface is a high speed serial interface, and may also be a USB interface, a Firewire interface, and an SPI interface.

TABLE 1
FUTABA GP1045A02A GRAPHIC DISPLAY
MODULE SPEFICATIONS

| | |
|---|---|
| Number of Dots (W × H mm) | 256 × 64 |
| Screen Size (W × H mm) | 163.6 × 39.4 |
| Dot Pitch (W × H mm) | 0.64 × 0.62 |
| External Dimensions (W × H × T mm) | 215.0 × 85.0 × 42.0 |
| Interface | CPU bus access |
| Power Supply (Vdc) | 5 |

In an embodiment, the display module microprocessor is a PICmicro® microcontroller, such as a PIC16F87x microcontroller available from Microchip Technology Inc, 2355 West Chandler Boulevard, Chandler, Ariz. 85224. A preferred microcontroller is the PIC16F877 Specifications for the PIC16F877 are provided in Table 2 below. Other commercially available microcontrollers may be used, such as a Phillips 89C51.

In an alternative embodiment, the display module may be battery operated and include an RF transceiver. Instructions may be wirelessly transmitted to the RF transceiver by a navigation system in the vehicle or located at a remote location. The display module may also include a GPS and transmitter for interacting with a navigation system, or may be a complete navigation system.

TABLE 2
MICROCHIP TECHNOLOGY INC.
PIC16F877 SPEFICATIONS

| | |
|---|---|
| Data RAM | 368 |
| Speed (MHz) | 20 |
| I/O Ports | 33 |
| ADC 10-bits | 8 |
| Serial I/O | USART/MSSP |

### EXAMPLE 1

### Exemplary Combined Navigation System and HUD

An exemplary combined navigation system and HUD in accordance with the present invention may be constructed with the components listed in Table 3 below. With regard to the micro-controller, this decodes the navigation system data and sends it to a buffer, which in turn is read to the HUD screen.

TABLE 3
COMPONENTS OF EXEMPLARY COMBINED
NAVIGATION SYSTEM AND HUD

| | |
|---|---|
| HUD MODULE | Vacuum Florescent Display (VFD) |
| COMPONENTS | An exemplary device can be obtained from Futaba. |
| | Micro-controller (8051, PIC) |
| | An exemplary device can be obtained from Philips, |
| | Microchip Technologies, or Cygnal |
| | Power supply circuitry. |
| | An exemplary device can be obtained from National |
| | Semiconductor |
| | Digital Brightness control circuitry. |
| | An exemplary device can be obtained from Dallas |
| | and National Semiconductor |
| | Ambient Light Sensor. |
| | Devices are commercially available. |
| NAVIGATION | Navigation Computer. |
| SYSTEM | An exemplary computer is in the NavMate ® Naviga- |
| COMPONENTS | tion System |
| | GPS. |
| | An exemplary device can be obtailed from Position, |
| | or Conexant. |
| | CD/DVD. |
| | An exemplary device can be obtained from Fujitsu- |
| | ten, Philips, or ToriSan (Sanyo) |
| SOFTWARE | Navigation and Locating Software. |
| | Exemplary software can be obtained from Visteon |
| | Technologies. |

### EXAMPLE 2

### Exemplary Serial Interface of HUD and Navigation System

In an embodiment, the display device, when connected to a navigating computer, can receive data (e.g., images) via a compressed serial link from the navigating computer memory. Preferably, the HUD (Heads Up Display) device is connected to a navigation system via a serial link. This serial link will allow the navigation system to send images to be transmitted onto the windscreen or displayed directly to the user when the device is tilted towards the user, which can be controlled by the navigation system in an embodiment by an invert/in-mirror routine. A preferred connector carries the following signals: power, data in, data out, and any control lines that might be necessary. Preferably, data is transferred at a high speed, preferably at least 19,200 baud or higher.

Images are preferably sent to the HUD via a compressed stream of data, for example using RLE (Run Length Encoding). Each frame to be displayed is uploaded to the target device (e.g., the HUD) and then the last displayed image is replaced with the most recent uploaded image. A pre-buffering or framing process relieves the user from watching the image being drawn on the display device at rates that could be perceived as slow or burdensome to the user.

Brightness-control and other control signals can be communicated with a simple acknowledge/not-acknowledge, or “ACK/NACK,” protocol that may be an adjunct protocol to the RLE image transmission protocol. For example, an ambient light sensor can send a signal to the microcontroller to increase or decrease the brightness.

An additional sensor may be added to the HUD to provide the microcontroller with the angle of the HUD output with respect to the HUD support stand or base, which would indicate if the images being transmitted need to be inverted (“un-mirrored”) for direct viewing rather than displays designed for viewing via reflection off a surface. This provides for using the HUD as a standard information display device.

In an alternative embodiment, the HUD may include an RF transceiver and data may also be radiotransmitted to the HUD from a navigation system or other device with a corresponding transmitter.

### EXAMPLE 3

### Exemplary Data Transmission Routine

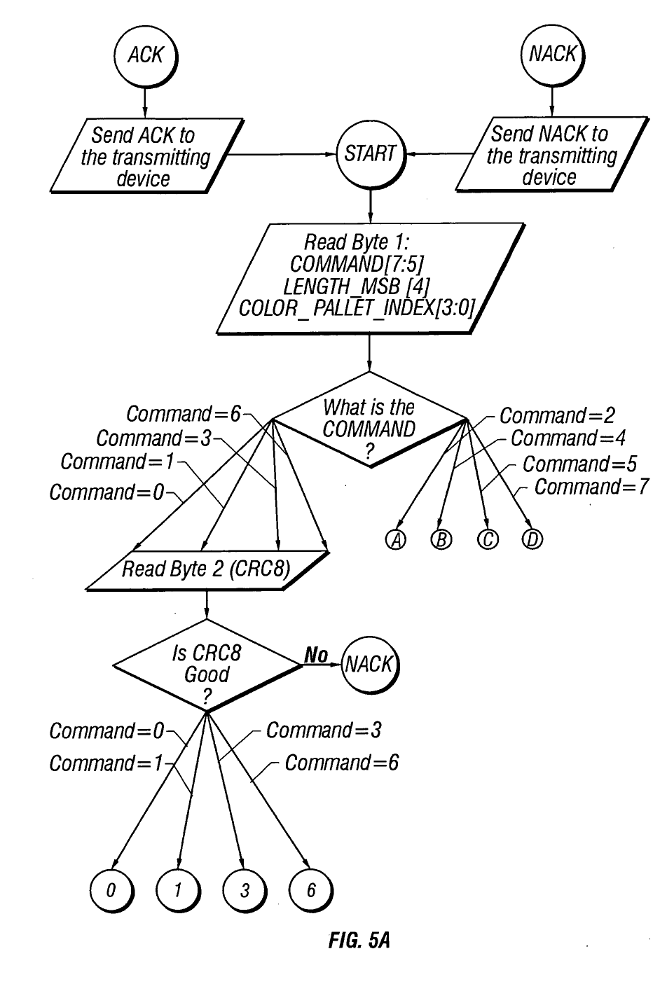

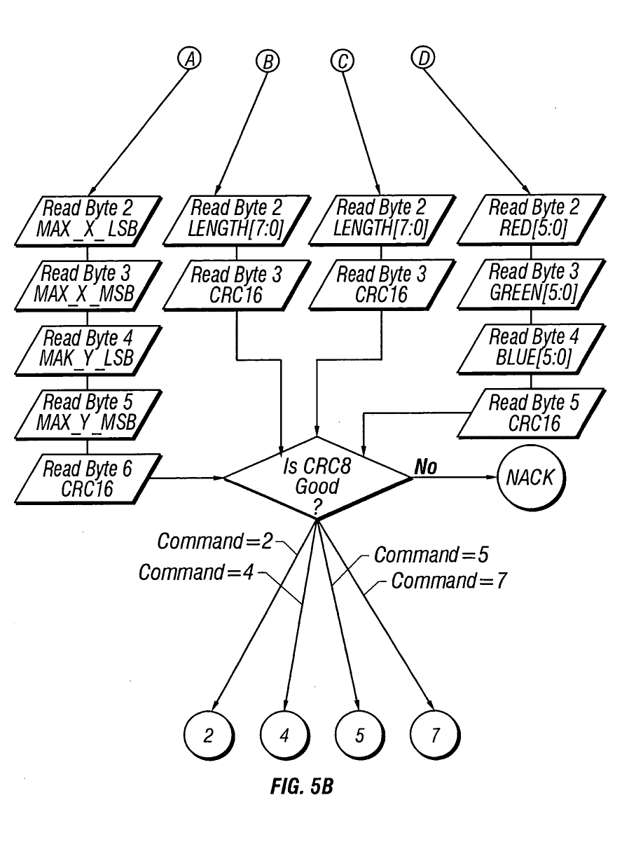

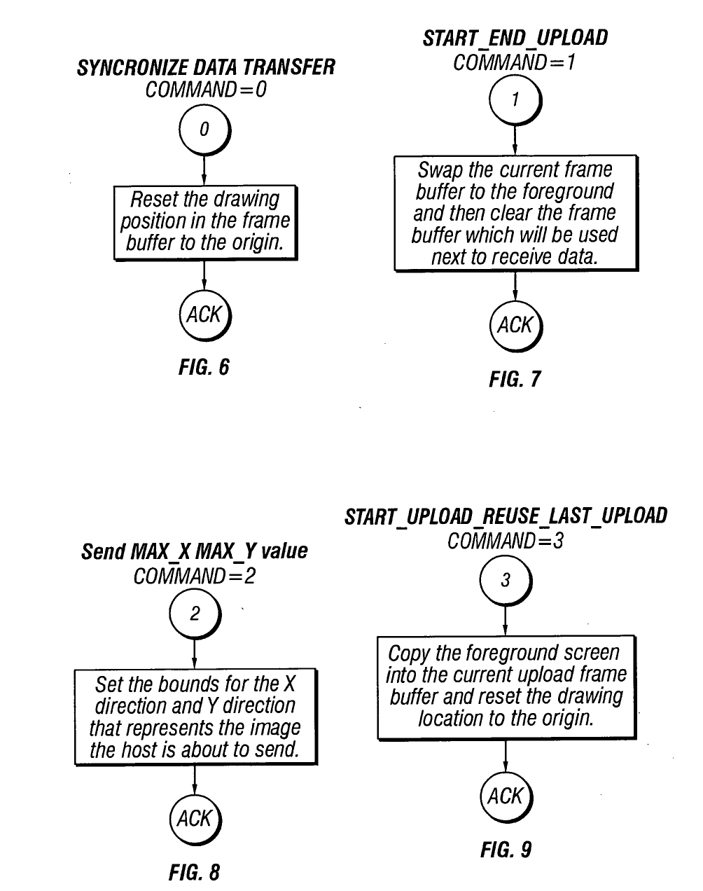

With reference to FIGS. 5a and 5b, an exemplary VLP (Variable Length Packet) protocol flow chart is illustrated. With reference to FIGS. 6-14, exemplary subroutine flows charts and program routines are illustrated. A VLP structured communication protocol optimizes the communication channel by reducing the overhead of command and control signals between the host and the target. This VLP communication protocol is intended for but not limited to data that is Run Length Encoded by the host. A breakdown of the possible byte streams from the host to the target is now described:

Byte 1: COMMAND[7:5], MSB_LENGTH[4], COLOR[3:0]

The First Byte is structured such that the first three bits (starting from the most significant bit, or “MSB”) contains the command to be processed by the target (i.e., bits 7 through 5 of the 8 bits), the next bit (i.e., bit 4) is a data bit which may or may not be used by the target depending on the command that is sent. The final 4 bits of the first byte (i.e., bits 0 through 3) sent by the host contain one of sixteen possible color selections for a run. A run is defined as a continual stream of color to be displayed on a sixteen-color depth screen. The color value does not represent the actual color being displayed, rather serves as an index into a color pallet, which is defined later on in the protocol via one of the eight possible commands.

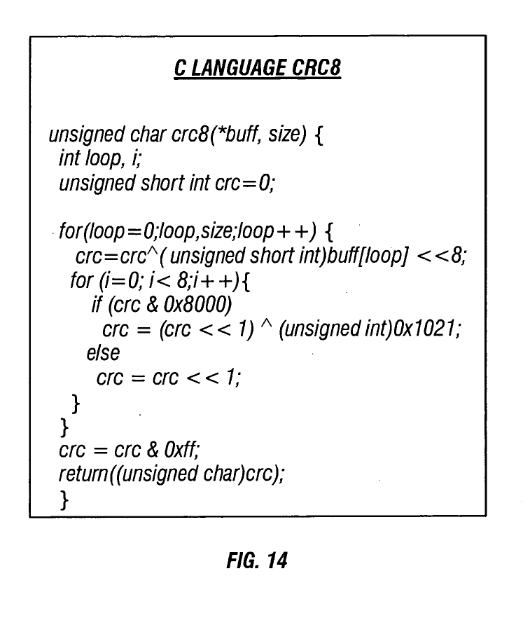

Bytes 2-6: The variations for Bytes 2 through 6 are set forth in the tables below:

| COMMAND | |
|---|---|
| (Binary) | CONTENTS OF BYTE 2 |
| 000 | CRC8 (Eight bit Cyclical Redundancy Code) for error |
| | checking. See FIG. 14 for a C-programming language |
| | example. |
| 001 | CRC8 |
| 010 | MAX_X_LSB (Least Significant Byte) |
| 011 | CRC8 |
| 100 | LENGTH[7:0], See also MSB_LENGTH[4] from Byte1 |
| | which should be appended to the beginning of the binary |
| | value LENGTH. |
| 101 | LENGTH[7:0], See also MSB_LENGTH[4] from Byte 1 |
| | which should be appended to the beginning of the binary |
| | value LENGTH. |
| 110 | CRC8 |
| 111 | RED 6 bit value (Bits 7 and 6 are for future expansion) |

| COMMAND | |
|---|---|
| (Binary) | CONTENTS OF BYTE 3 |
| 010 | MAX_X_MSB (Most Significant Byte) |
| 100 | CRC8 |
| 101 | CRC8 |
| 111 | BLUE 6 bit value (Bits 7 and 6 are for future expansion) |

| COMMAND | |
|---|---|
| (Binary) | CONTENTS OF BYTE 4 |
| 010 | MAX_Y_LSB (Least Significant Byte) |
| 111 | GREEN 6 bit value (Bits 7 and 6 are for future expansion) |

| COMMAND | |
|---|---|
| (Binary) | CONTENTS OF BYTE 5 |
| 010 | MAX_Y_MSB (Most Significant Byte) |
| 111 | CRC8 |

| COMMAND | |
|---|---|
| (Binary) | CONTENTS OF BYTE 6 |
| 010 | CRC8 |

Command Code Description: The eight possible command codes are described in order below. FIGS. 6 through 13 provide eight subroutine flowcharts corresponding to which command is given.
Command Code 000(Binary):

Referring to FIG. 6, entitled “Synchronize Data Tranfer” (SYNC), this command will reset any run/pixel counters as well as any running Cyclical Redundancy Code (CRC) calculations.

Command Code 001(Binary):

Referring to FIG. 7, entitled START_END_UPLOAD, this command will set x=0, and y=0 and move the destination frame buffer to a background frame buffer which is not visible and move the last background frame to the foreground.

Command Code 010(Binary):

Referring to FIG. 8, entitled SEND_MAX_X_Y value, this command will let the target know what dimensions the host expects the target to support (e.g., pixels in a preferred embodiment are a maximum of 256 in the X direction and 64 in the Y direction, or MAXX=256, MAXY=64).

Command Code 011 (Binary):

Referring to FIG. 9, entitled START_UPLOAD_REUSE_LAST_UPLOAD, this command copies the foreground image into the background image buffer and then resets the start position for the tracer to the beginning of the display devices origin. The tracer is the virtual pen pointer which represents the position from which drawing commands are referenced.

Command Code 100(Binary):

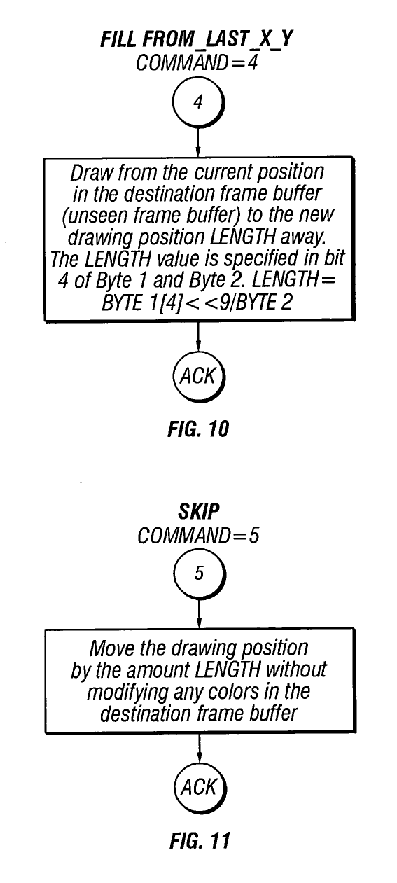

Referring to FIG. 10, entitled FILL FROM LAST_X_Y, this command will paint the specified color from the last know X and Y position to the new X and Y position which is LENGTH away from the original position.

Command Code 101(Binary):

Referring to FIG. 11, entitled SKIP, this command skips LENGTH in pixels from the last X and Y position on the display device without changing any of the current colors in that region of the display device.

Command Code 110(Binary):

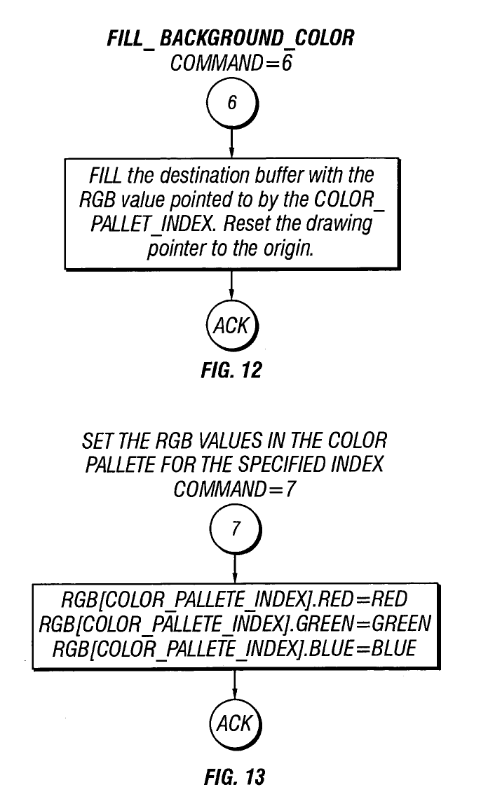

Referring to FIG. 12, entitled FILL BACKGROUND_COLOR, this command will fill the background with the specified color.

Command Code 111(Binary):

Referring to FIG. 13, entitled SET_COLOR_PALLET_TABLE_ENTRY, this command sends three bytes, which represent the 18 Bit RGB actual color value for a specified color index. The color index is specified in Byte 1. The specified RGB value will then be used by the display device to display a pixel based on a color pallet index. The R, G, and B values may also represent the level or brightness of a monochromatic pixel.

Handling Error Detection:

After sending the command and the associated data, an ACK will be sent or a NACK depending if the terminating eight-bit CRC (Cyclical Redundancy Code) value is correct. The CRC code is generated using a loop method routine set forth in FIG. 14. It can however be pre-generated in a lookup-table for speed.

Simple Instruction Set

The devices and method of providing navigation instructions of the present invention enable a simplified set of navigation assistance images to be displayed. For example, a command from the navigation system to turn right at a distance of 150 feet could be converted to HUD images, such as >150, [symbol] 150, [symbol] 150, or other easy to follow directional symbol image.

In an embodiment, the symbols remain on the HUD until replaced by the next direction or until a specified period of time passes and the display is automatically dimmed. By transmitting the direction image via serial interface to a buffer, the driver is not distracted by a slowly changing image, and is only notified of the most recent instruction with minimal distraction or thought required to understand the directions being given by the navigation system.

Thus, in a preferred embodiment, a navigation command is converted to an image, the image data is compressed to speed transfer (e.g., via run length encoding, “RLE”), the compressed data is transmitted serially to the HUD, the image data is translated and stored in a buffer, and the current imaged swapped for the new image when the complete data set for the new image is in the buffer. In an embodiment, the HUD device has dimensions suitable for mounting on the dash of a Jeep Grand Cherokee, with corresponding operative coupling to a navigation system.

While a new navigation system with HUD and operating software therefore have been disclosed in an exemplary fashion, there could be a wide range of changes without departing from the present invention. Thus, it is intended that the foregoing detailed description be regarded as illustrative rather than limiting and that it be understood that it is the following claims, including all equivalents, which are intended to define the scope of the invention.

What is claimed is:

1. A navigation system with heads up display, comprising:
a navigation system computer for providing navigation instructions,
a heads up display unit for receiving and outputting navigation instructions from said computer, said heads up display being in operative connection with said computer for receiving instructions from said computer and outputting said instructions in the form of a visual image,
said heads up display unit comprising a housing rotatably mounted on a base, said housing holding an image generator device, wherein a user may place said base on a vehicle dashboard and rotatably adjust said housing to view the reflection of an image generated by said display device from the vehicle windshield or view the display directly.

2. The navigation system of claim 1, wherein said image generator device comprises a vacuum fluorescent display.

3. The navigation system of claim 1, wherein said navigation system computer comprises a NavMate® Navigation System.

4. The navigation system of claim 1, wherein said image generator device comprises a plurality of vacuum fluorescent display elements.

5. The navigation system of claim 1, wherein said display unit is in serial communication with said navigation system computer.

6. The navigation system of claim 1, wherein said display unit further comprises a serial interface selected from the group consisting of an RS232 interface, a USB interface, a Firewire interface, and an SPI interface.

7. The navigation system of claim 1, wherein said display unit further comprises an RS232 interface.

8. The navigation system of claim 1, wherein said display unit further comprises at least one of the group consisting of a microcontroller, and a frame buffer.

9. The navigation system of claim 7, wherein said display unit further comprises a Futaba GP1045A02A graphic display module, and a PICmicro® microcontroller model number PIC16F87x

10. The navigation system of claim 1, wherein said image generator device can be used as standard information display device when rotated towards the user, wherein said system detects the angular position of said information display with respect to said base, and said navigation system inverts or does not invert the image depending on said angular position.

11. A vehicle heads up display unit, comprising an image generator device, and a serial interface, wherein said display unit may be utilized to display images transmitted thereto via serial interface.

12. The display unit of claim 11, further comprising a frame buffer.

13. The display unit of claim 11, wherein said image generator device comprises a vacuum fluorescent display.

14. The display unit of claim 11, wherein said serial interface is selected from the group consisting of an RS232 interface, USB interface, a Firewire interface, and an SPI interface.

15. The display unit of claim 11, wherein said serial interface comprises an RS232 interface.

16. The display unit of claim 11, further comprising a microcontroller.

17. The display unit of claim 11, further comprising at least one of the group consisting of an RF transceiver, a battery power input, and an RJ11 jack.

18. The display unit of claim 12, wherein said image generator device comprises a vacuum fluorescent display.

19. The display unit of claim 18, wherein said image generator device comprises a Futaba GP1045A02A graphic display module.

20. The display unit of claim 12, further comprising a microcontroller.

21. The display unit of claim 20, wherein said microcontroller comprises a PICmicro® microcontroller model number PIC16F87x.

22. The display unit of claim 18, further comprising a microcontroller.

23. The display unit of claim 22, wherein said microcontroller comprises a PICmicro® microcontroller model number PIC16F87x, said serial interface comprises an RS232 interface, and said image generator device comprises a Futaba GP1045A02A graphic display module.

24. The display unit of claim 23, further comprising at least one of the group consisting of an RF transceiver, a battery power input, and an RJ11 jack.

25. A method of providing navigation instructions to a heads up video display, comprising providing navigation instructions via a serial interface to a heads up display unit.

26. The method of claim 25, wherein said navigation instructions are provided in the form of digital data corresponding to symbolic commands created by a navigation system, said digital data being sent from the navigation system to the video display following a variable length packet protocol.

27. The method of claim 26, wherein said data is run length encoded.

28. The method of claim 26, wherein instruction data serially received by the heads up display is translated and stored in a buffer.

29. The method of claim 27, wherein instruction data serially received by the heads up display is translated and stored in a buffer.

30. The method of claim 25, wherein data corresponding to a s navigation instruction is translated by said HUD and stored in a buffer until the complete command is received prior to displaying the information contained in the navigation instruction.

31. The method of claim 25, wherein said serial interface is selected from the group consisting of an RS232 interface, USB interface, a Firewire interface, and an SPI interface.
